(19) United States
(12) Patent Application Publication
(10) Pub. No.: US 2007/0127358 A1
(43) Pub. Date: Jun. 7, 2007

(54) Phase correction in a test receiver

(75) Inventors: Thomas Sun, San Diego, CA (US); Durk L. van Veen, Santee, CA (US); Fuyun Ling, San Diego, CA (US); Murali Ramaswamy Chari, San Diego, CA (US); Raghuraman Krishnamoorthi, San Diego, CA (US)

Correspondence Address: QUALCOMM INCORPORATED, 5775 MOREHOUSE DR., SAN DIEGO, CA, 92121, US

(73) Assignee: QUALCOMM Incorporated

(21) Appl. No.: 11/417,400

(22) Filed: May 3, 2006

Related U.S. Application Data
(63) Continuation-in-part of application No. 11/361,085, filed on Feb. 22, 2006.
(63) Continuation-in-part of application No. 11/361,088, filed on Feb. 22, 2006.
(60) Provisional application No. 60/739,481, filed on Nov. 23, 2005.
(60) Provisional application No. 60/739,491, filed on Nov. 23, 2005.

(51) Int. Cl. H04J 11/00; H04J 3/06

(52) U.S. Cl. 370/203; 370/516

(57) ABSTRACT

The claimed subject matter relates to analyzing performance of a transmitter. This can be accomplished, for instance, through partitioning a super frame into a plurality of segments, and thereafter estimating and correcting phase with respect to at least one of the plurality of segments. Thereafter, additive noise can be determined with respect to the at least one segment. For instance, the super frame can include multiple OFDM symbols, and the transmitter can be a FLO transmitter.

### CROSS-REFERENCE TO RELATED APPLICATIONS

This application is a continuation in part of U.S. patent application Ser. Nos. 11/361,085 and 11/361,088, entitled EVALUATION OF TRANSMITTAL PERFORMANCE and MODULATION TYPE DETERMINATION FOR EVALUATION OF TRANSMITTAL PERFORMANCE, respectively, both filed on Feb. 22, 2006. This application also claims the benefit of U.S. Provisional Patent application Ser. No. 60/739,481, entitled “METHODS AND APPARATUS FOR COLLECTING INFORMATION FROM A WIRELESS DEVICE,” which was filed Nov. 23, 2005. The entirety of the aforementioned applications are incorporated herein by reference.

### I. FIELD

The following description relates generally to communications systems, and more particularly to testing and monitoring transmitter performance.

### II. BACKGROUND

Wireless networking systems have become a prevalent means to communicate with others worldwide. Wireless communication devices, such as cellular telephones, personal digital assistants, and the like have become smaller and more powerful in order to meet consumer needs and to improve portability and convenience. Consumers have become dependent upon these devices, demanding reliable service, expanded areas of coverage, additional services (e.g., web browsing capabilities), and continued reduction in size and cost of such devices.

A typical wireless communication network (e.g., employing frequency, time, and code division techniques) includes one or more base stations that provides coverage areas to subscribers as well as mobile (e.g., wireless) devices that can transmit and receive data within the coverage areas. A typical base station can simultaneously transmit multiple data streams to multiple devices for broadcast, multicast, and/or unicast services, wherein a data stream is a stream of data that can be of independent reception interest to a user device. A user device within the coverage area of that base station can be interested in receiving one, more than one or all the data streams carried by the composite stream. Likewise, a user device can transmit data to the base station or another user device.

Forward Link Only (FLO) technology has been developed by an industry group of wireless communication service providers to utilize the latest advances in system design to achieve the highest-quality performance. FLO technology is intended for a mobile multimedia environment and is suited for use with mobile user devices. FLO technology is designed to achieve high quality reception, both for real-time (streaming) content and other data services. FLO technology can provide robust mobile performance and high capacity without compromising power consumption. In addition, the technology reduces the network cost of delivering multimedia content by decreasing the number of base station transmitters that are necessarily deployed. Furthermore, FLO technology based multimedia multicasting is complimentary to wireless operators' cellular network data and voice services, as cellular network data can be delivered to a same device that receives multimedia content by way of FLO technology.

Performance of transmitters, both within base stations and mobile devices, is crucial to success of a wireless system generally and in connection with FLO technology in particular. Additionally, as alluded to above, it is desirable to maintain low costs with respect to transmitters within wireless systems. Accordingly, wireless service providers may wish to determine performance of a transmitter designed and provided by a vendor prior to finalizing purchase of the transmitter. For instance, performance of channel estimation may be desirable to enable determination of signal-to-noise ratio, modulation error ratio, and various other performance metrics. More particularly, it may be desirable to perform phase correction with respect to transmitted signals and thereafter analyze particular parameters of a resultant signal to analyze transmitter performance. Conventional phase estimation and correction techniques, however, are computationally expensive or are not associated with sufficient accuracy to enable meaningful analysis of transmitter performance.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

The claimed subject matter relates to testing performance of a transmitter. Such testing can be performed while the transmitter is in the field, within a factory, etc. In an example, modulation error ratio can be indicative of how a transmitter is performing, and accordingly, such ratio can be required to reside within a particular range. To determine modulation error ratio, phase estimation and correction with respect to a super frame may need to be undertaken. Estimating and correcting phase alteration over an entirety of a super frame, however, may not sufficiently cancel nonlinear noise associated with the transmitter/super frame, thereby not enabling determination of an accurate modulation error ratio. Accordingly, the claimed subject matter relates to segmenting the super frame with respect to time and thereafter performing phase estimation/correction over individual segments. For example, a first order and/or a second order phase correction algorithm can be employed.

In accordance with an aspect, a method for analyzing performance of a transmitter comprises partitioning a super frame into a plurality of segments and estimating and correcting phase with respect to at least one of the plurality of segments. The method can also include determining additive noise with respect to the at least one segment. For instance, the super frame can include several OFDM symbols. Additionally, first and/or second order phase correction algorithms can be employed.

With respect to another aspect, a wireless communications apparatus described herein includes a memory that retains instructions for segmenting a super frame with respect to time upon receipt of the super frame and further retains instructions for correcting phase alteration with respect to the super frame. The wireless communications apparatus can also include a processor, wherein the processor executes the instructions retained within memory to correct phase alteration with respect to at least one segment of the super frame.

In accordance with still another aspect, a wireless communications apparatus described herein comprises means for partitioning a super frame received from a transmitter into a plurality of segments, and means for performing phase correction with respect to at least one of the segments. The wireless communications apparatus also includes means for determining a performance metric with respect to the transmitter based at least in part upon the phase correction. Additionally, the wireless communications apparatus can include means for performing channel estimation based at least in part upon the phase correction.

In accordance with still another aspect, a machine-readable medium is described herein, wherein the machine readable medium has stored thereon machine-executable instructions for receiving a first portion of a super frame and estimating and correcting phase alteration with respect to the first portion in connection with testing performance of a transmitter. The machine-readable medium can include additional machine-executable instructions for determining modulation error ratio based at least in part upon the corrected phase alteration.

In accordance with yet another aspect, a processor is described herein, wherein the processor executes instructions for determining timing information in connection with segmenting a received signal that includes multiple symbols. The processor can also execute instruction for segmenting the received signal in accordance with the determining timing information as well as instructions for correcting phase alteration with respect to at least one segment of the received signal, wherein the at least one segment comprises two or more symbols. The processor can additionally execute instructions for determining whether a transmitter is performing adequately based at least in part upon the corrected phase alteration.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a high level block diagram of a system that facilitates segmenting a super frame and performing phase correction with respect to individual segments.

FIG. 2 is a block diagram of a system that segments a super frame and performs phase estimation and correction upon one or more segments.

FIG. 3 is an illustration of a wireless communication system.

FIG. 4 is a high level block diagram of a wireless communications apparatus that can perform phase estimation and correction on segments of a super frame.

FIG. 5 is a graphical representation of a linear estimation of phase alteration over an entirety of a super frame in comparison to an actual phase alteration.

FIG. 6 is a graphical representation of a second order estimation of phase alteration over an entirety of a super frame in comparison to an actual phase alteration.

FIG. 7 is a graphical representation of estimations of phase alteration of segments of a super frame.

FIG. 8 is a representative flow diagram illustrating a methodology for estimating and correcting phase alteration.

FIG. 9 is representative flow diagram illustrating a methodology for estimating and correcting phase alteration.

FIG. 10 is a functional block diagram of an apparatus that is utilized to estimate and correct phase alteration.

FIG. 11 is an illustration of a transmitter evaluation system.

FIG. 12 is an illustration of a wireless communication system.

FIG. 13 is an illustration of a transmitter evaluation system.

FIG. 14 is a constellation diagram illustrating the difference between measured signal and transmitted signal.

FIG. 15 illustrates a methodology for evaluating a transmitter.

FIG. 16 illustrates a methodology for evaluating a transmitter.

FIG. 17 illustrates a methodology for generating coarse channel estimates.

FIG. 18 illustrates a methodology for determining modulation symbols.

FIG. 19 illustrates a methodology for determining modulation symbols.

FIG. 20 illustrates the division of a constellation diagram into regions.

FIG. 21 illustrates a methodology for evaluating a transmitter using phase correction.

FIG. 22 is an illustration of a system that evaluates transmitter performance in a wireless communication environment.

FIG. 23 illustrates an example base station.

FIG. 24 is an illustration of a wireless communication environment that can be employed in conjunction with the various systems and methods described herein.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that such subject matter may be practiced without these specific details. In other instances, well-known structures and devices are shown in block diagram form in order to facilitate describing the claimed subject matter.

Furthermore, various aspects are described herein in connection with a user device. A user device can also be called a system, a subscriber unit, subscriber station, mobile station, mobile device, remote station, remote terminal, access terminal, user terminal, terminal, user agent, or user equipment. A user device can be a cellular telephone, a cordless telephone, a Session Initiation Protocol (SIP) phone, a wireless local loop (WLL) station, a PDA, a handheld device having wireless connection capability, or other processing device connected to a wireless modem.

Moreover, aspects of the claimed subject matter may be implemented as a method, apparatus, or article of manufacture using standard programming and/or engineering techniques to produce software, firmware, hardware, or any combination thereof to control a computer or computing components to implement various aspects of the claimed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive, . . . ). Additionally it should be appreciated that a carrier wave can be employed to carry computer-readable electronic data such as those used in transmitting and receiving voice mail or in accessing a network such as a cellular network. Of course, those skilled in the art will recognize many modifications may be made to this configuration without departing from the scope or spirit of what is described herein.

Base station transmitter performance is vital to the overall performance of a wireless system, particularly a wireless system utilizing FLO technology. Accordingly, prior to placing a transmitter in the field of use, it is desirable to test such transmitter to ensure that it is operating within certain specifications. In one example, it may be desirable to ascertain modulation error ratio (MER) with respect to a transmitter to ensure that MER falls within specifications. MER indicates mean or maximum deviation of I/Q values with respect to ideal signal states, and thus provides a measure of signal quality output by a transmitter. Computation of MER is described in greater detail below. In another example, group delay, frequency response (in-band and out-band), and other parameters can be determined to ensure that the transmitter accords to specifications. Still further, additive noise (e.g., noise that can be attributed to power amplifiers, filters, D/A converters, . . . ) can be computed to analyze transmitter performance. To enable determination of these and other parameters, channel estimations of each OFDM symbol within a super frame can be averaged to obtain a mean value—however, it is desirable to correct phase alterations due to frequency offset prior to undertaking the aforementioned averaging.

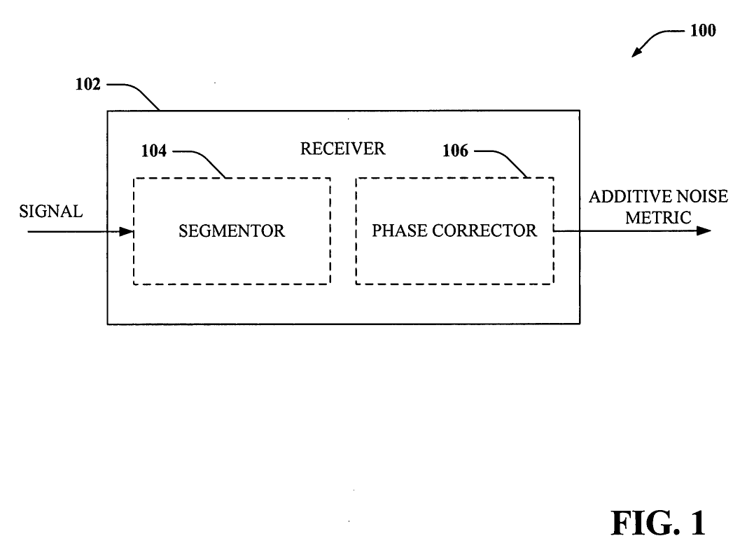

Referring now to FIG. 1, a system 100 that facilitates correcting phase associated with a received signal (e.g., a super frame) is illustrated. For example, the received signal can conform to Orthogonal Frequency Division Multiplexing (OFDM), such that a super frame includes 1200 OFDM symbols. It is understood, however, that any suitable frequency-division protocol that includes any suitable number of symbols is contemplated by the inventors and intended to fall under the scope of the hereto-appended claims. Frequency division based techniques, such as OFDM, typically separate the frequency spectrum into distinct channels by splitting the frequency spectrum into uniform chunks of bandwidth. For example, the frequency spectrum or band allocated for wireless cellular telephone communication can be split into 30 channels, each of which can carry a voice conversation, digital service, digital data, and/or the like. Each channel can be assigned to only one user device or terminal at a time. OFDM effectively partitions the overall system bandwidth into multiple orthogonal frequency channels. An OFDM system may use time and/or frequency division multiplexing to achieve orthogonality among multiple data transmissions for several terminals. For example, different terminals may be allocated different channels, and the data transmission for each terminal may be sent on the channel(s) allocated to such terminal. By using disjoint or non-overlapping channels for different terminals, interference among multiple terminals may be avoided or reduced, and improved performance may be achieved.

The system 100 includes a receiver 102 that receives the signal, wherein such receiver can be a test receiver that is utilized in connection with ensuring that a transmitter (not shown) is performing according to specifications. For some transmitters, a frequency offset associated with output signals may not be constant. In other words, alteration of phase is not linear with time. Accordingly, it is desirable to compensate the phase ramp to enable averaging of channel estimations of each symbol within a super frame (thus enabling transmitter performance parameters, such as MER, to be discerned). Mathematically, the received signal with a frequency offset can be written as:

$$r ( t ) = {\sum }_{n = 0}^{N - 1} {R}_{n} {ⅇ}^{j ( {ω}_{0} + n {ω}_{s} + Δω ) t} ,$$

where Rₙ is the complex amplitude of the nth sub carrier, ω₀ is the frequency of a zeroth sub carrier (at an intermediate frequency (IF) upon which the zeroth sub carrier is processed), ωₛ is the sub carrier spacing, Δω is the frequency offset, and t is time.

From reviewing the above algorithm, it can be ascertained that a constant frequency offset results in a phase change that is linear with time, while a frequency offset that is linear with time results in a phase change that is parabolic with respect to time. As stated above, correction of phase change is desirable prior to averaging channel estimations associated with OFDM symbols within a super frame, for example. Theoretically, if a channel is perfect, phase change due to constant frequency offset can be cancelled by way of calculating slope of such phase change and utilizing a first order least-square phase correction algorithm based upon the calculated slope. Such an algorithm is provided below:
φₑₛₜ=a·t+b,
where parameters a, b are determined by least-square estimation algorithm. Additionally or alternatively, a first order phase correction algorithm can be of the form

$$\begin{matrix}\frac{ⅆ φ}{ⅆ t} = \frac{1}{{T}_{OFDM}} {\sum }_{l = 0}^{L} {Δφ}_{l + 1} \\ = \frac{{φ}_{L} - {φ}_{0}}{L} ,\end{matrix}$$

where Δφₖ₊₁=φₖ₊₁−φₖ is the phase change of a channel estimation of two adjacent OFDM symbols, and T_{OFDM} is a time period. If, on the other hand, it is assumed that the frequency offset is linear over time, then a second order least-squared algorithm can be utilized to discern parameters a, b, and c. The estimated phase can be written as:
φₑₛₜ=a·t²+b·t+c.

Typically, however, assumptions of constancy and linearity with respect to frequency offset over an entirety of a super frame are inaccurate, such that correcting phase alteration through use of first or second order algorithms does not enable sufficiently accurate averaging of channel estimates. To increase accuracy of estimates of phase alterations, a segmentor 104 can be employed to partition a super frame according to time. In other words, a super frame can be associated with a time T, and such time segment can be partitioned into N time segments (e.g., time segments that accord to 300 OFDM symbols), where N can be any suitable number. Assumptions relating to constancy and linearity with respect to a frequency offset over the plurality of time segments individually enable a much more accurate estimation of phase alteration of the received signal.

To calculate MER, however, it may not be desirable to increase N to an extremely large number, such as equating N to a number of OFDM symbols within a super frame. In more detail, if N is selected as being very large, then additive noise (which is desirably retained for analysis) will be cancelled together with nonlinear noise. With more specificity, a noise term with respect to a channel for each OFDM symbol derived from the received signal can be decomposed into two orthogonal dimensions: \vec{a} (amplitude direction) and \vec{p} (phase direction). A noise term in the \vec{a} dimension can be considered additive white Gaussian noise n_{\vec{a}} (k, n), where k is a sub carrier index and n is an OFDM symbol index. A noise term in the \vec{p} dimension can be considered as a summation of additive white Gaussian noise n_{\vec{p}} (k, n), with distortion d_{\vec{p}} (k, n) associated with the frequency offset Δω. With respect to calculating MER, it is desirable to reduce or eliminate d_{\vec{p}} (k, n) while not eliminating n_{\vec{p}} (k, n).

In one example, if the variance of n_{\vec{a}} (k, n) is substantially similar to that of _{\vec{p}} (k, n), N can be set to a number of symbols being processed (e.g., a number of symbols within a super frame). Thus, both n_{\vec{p}} (k, n) and d_{\vec{p}} (k, n) are eliminated. In such an instance, a true MER will be equal to a processing MER minus a constant (e.g., 3.01 dB). In another example, segmentor 104 can perform segmentation with respect to time, where time is associated with a number of symbols being processed, such that the nonlinear noise (d_{\vec{p}} (k, n)) is substantially cancelled while the additive (quantization) noise n_{\vec{p}} (k, n) is left substantially unchanged. A number of segments can be determined empirically, for instance. In yet another example, a super frame can be segmented into four segments (N=4).

Once segmentor 104 performs appropriate segmentation, a phase corrector 106 can estimate and correct phase alteration through use of a linear estimation or a second order estimation. For example, once phase corrector 106 estimates phase alteration through first and/or second order estimation algorithms, phase corrector 106 can utilize the linear estimation or the second order estimation to substantially cancel nonlinear noise while retaining quantization noise (additive noise). Such estimation can be undertaken, for instance, to compensate for the phase alteration, thereby enabling an average of channel estimations with respect to each OFDM symbol to be achieved.

While shown as being comprised within receiver 102, it is understood that segmentor 104 and phase corrector 106 can be located in any suitable computing device that can be coupled to a transmitter (e.g., directly coupled to a transmitter to maintain a clean channel). Additionally, segmentor 104 and phase corrector 106 can be employed to test a transmitter that is desirably utilized in a FLO broadcasting system. A FLO wireless system can be designed to broadcast real time audio and video signals, as well as non-real time services. The respective FLO transmission is carried out utilizing tall, high power transmitters to ensure wide coverage in a given geographical area. It is common to deploy multiple transmitters in certain regions to ensure that the FLO signal reaches a significant portion of the population in a given area. Typically, FLO technology utilizes OFDM to transmit data. It is to be understood, however, that the claimed subject matter is applicable to various communications protocols (wireless or wirelined, multiple carrier or single carrier).

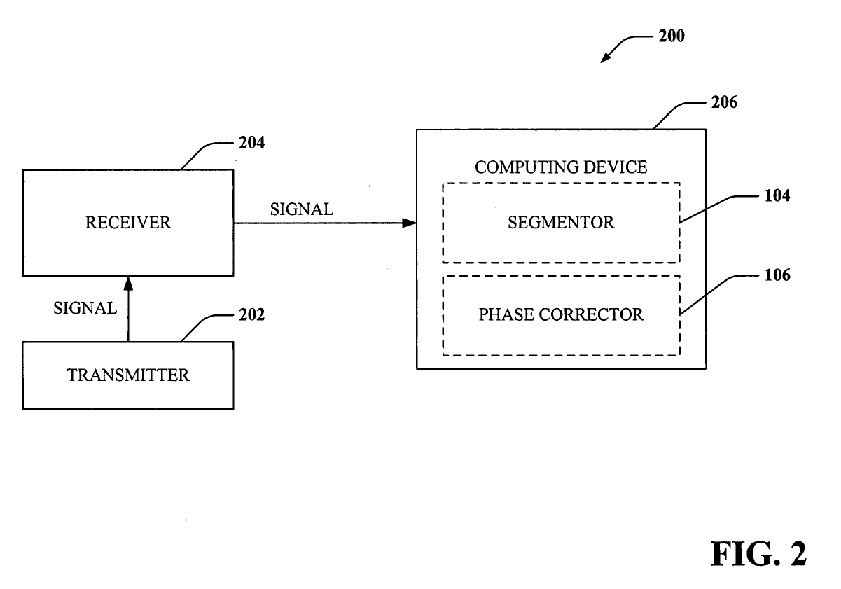

Referring now to FIG. 2, a system 200 that facilitates analyzing performance of a transmitter for utilization in a FLO broadcasting system is illustrated. The system 200 includes a transmitter 202 that is communicatively coupled to a receiver 204. The coupling can be wireless coupling, wirelined coupling, or any other suitable coupling. In an example, transmitter 202 and receiver 204 can be in close proximity in an attempt to simulate a clean channel. Receiver 204 can in turn be communicatively coupled to a computing device 206, which can include segmentor 104 and phase corrector 106. The system 200 is intended to illustrate that operations of segmentor 104 and phase corrector 106 can be undertaken outside of receiver 204. Moreover, transmitter 202 and computing device 206 can be directly connected if computing device 206 includes functionality that enables receipt of signals.

As described above, segmentor 104 segments a time frame associated with desirably processed symbols into a plurality of time segments. A number of time segments can be adjustable depending upon a number of processed symbols, can be selected through analyzing empirical data, or any other suitable manner for determining an appropriate number of segments. Phase corrector 106 can utilize a first or second order estimation algorithm in connection with estimating and correcting phase alteration, such as to significantly reduce nonlinear noise while retaining quantization noise (noise from amplifiers, filters, etc.). Additionally, a least-squared model can be employed by phase corrector 106 with respect to both first and second order phase estimation and correction. Segmenting in the above-described manner enables additive (quantization) noise to be retained for analysis while substantially canceling nonlinear noise.

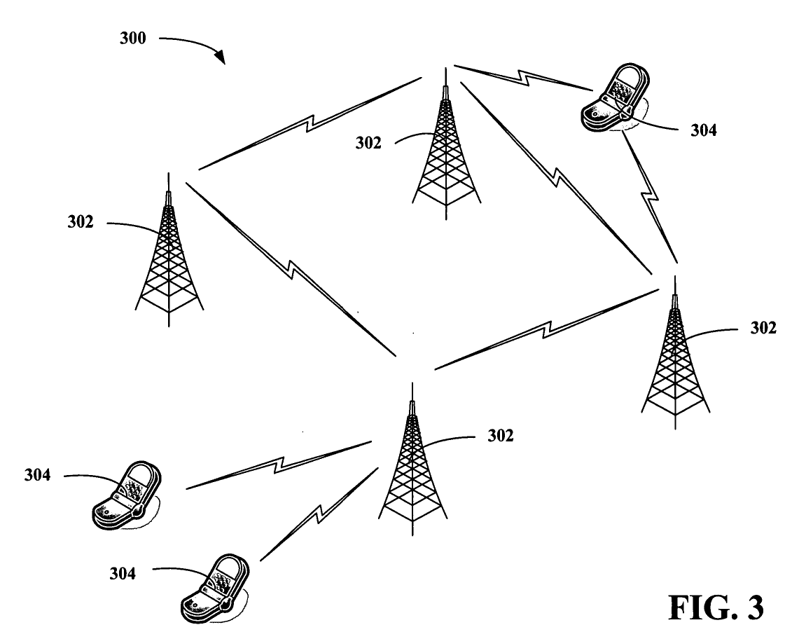

Referring now to FIG. 3, an example wireless communication system 300 is illustrated. System 300 can include one or more base stations 302 in one or more sectors that receive, transmit, repeat, etc., wireless communication signals to each other and/or to one or more mobile devices 304. A base station may be a fixed station used for communicating with terminals and may also be referred to as an access point, a Node B, or other terminology. Each base station 302 can comprise a transmitter chain and a receiver chain, each of which can in turn comprise a plurality of components associated with signal transmission and reception (e.g., processors, modulators, multiplexers, demodulators, demultiplexers, antennas, . . . ), as will be appreciated by one skilled in the art. Mobile devices 304 can be, for example, cellular phones, smart phones, laptops, handheld communication devices, handheld computing devices, satellite radios, global positioning systems, PDAs, and/or any other suitable device for communicating over wireless system 300. In addition, each mobile device 304 can comprise one or more transmitter chains and receiver chains, such as used for a multiple input multiple output (MIMO) system. Each transmitter and receiver chain can include a plurality of components associated with signal transmission and reception (e.g., processors, modulators, multiplexers, demodulators, demultiplexers, antennas, . . . ), as will be appreciated by one skilled in the art.

Each of the base stations 302 and mobile devices 304 can include one or more transmitters utilized to transmit signals to other base stations and mobile devices. Transmitters can be tested prior to utilization of such transmitters within a wireless communications environment. As described above, the transmitters can be associated with test receivers to enable testing of certain parameters relating to the transmitters. For instance, a series of desirably processed symbols can be partitioned with respect to time, such that a subset of symbols is analyzed. Thereafter, first and/or second order phase correction can be undertaken with respect to each subset of symbols, thus enabling more accurate estimation and correction of phase alteration. Additionally, white Gaussian noise can be retained while distortion is substantially compensated, thereby facilitating calculation of a metric that describes performance of the transmitter.

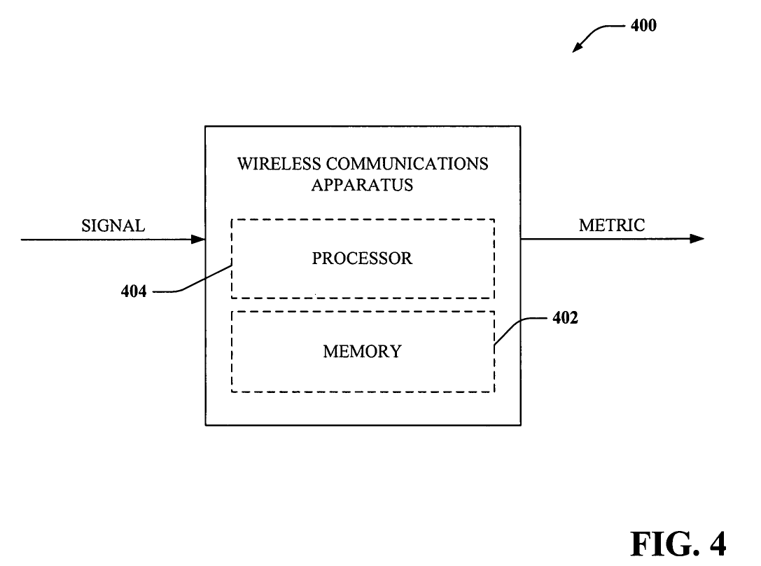

Now turning to FIG. 4, a wireless communications apparatus 400 that can be utilized in connection with testing a transmitter is illustrated. In more detail, the wireless communications apparatus 400 can be employed to segment a super frame with respect to time and thereafter perform phase correction on such segments. The wireless communications apparatus 400 can include a memory 402 that can maintain logic, code, and the like that enables, for instance, a super frame to be segmented with respect to time. Additionally, memory 402 can include logic, code, and/or instructions for estimating/correcting phase, alteration caused by a frequency offset. Pursuant to an example, memory 402 can include a first order algorithm that facilitates estimating and correcting phase alteration. Moreover, memory 402 can include a least square-based second order algorithm that enables phase alteration to be accurately estimated and corrected. The algorithms in memory 402 can be utilized to estimate/correct phase alteration within various segments.

Wireless communications apparatus 400 additionally includes a processor 404 that can analyze a received signal and segment such signal according to instructions within memory 402. The received signal can be a super frame that includes a plurality of symbols (e.g., OFDM symbols), and processor 404 can segment the super frame into a plurality of partitions. As can be appreciated, segmenting the super frame is done with respect to time, as symbols of the super frame are received sequentially at a receiver. Processor 404 can, upon segmenting at least a portion of the super frame, execute instructions within memory 402 relating to estimating/correcting phase alteration in the received signal. As described above, processor 404 can employ a first order estimation/correction algorithm and/or a second order estimation/correction algorithm in connection with estimating/correcting phase alteration. Additionally, processor 404 can output a metric indicating transmitter performance, such as an amount of additive noise associated with the received signal.

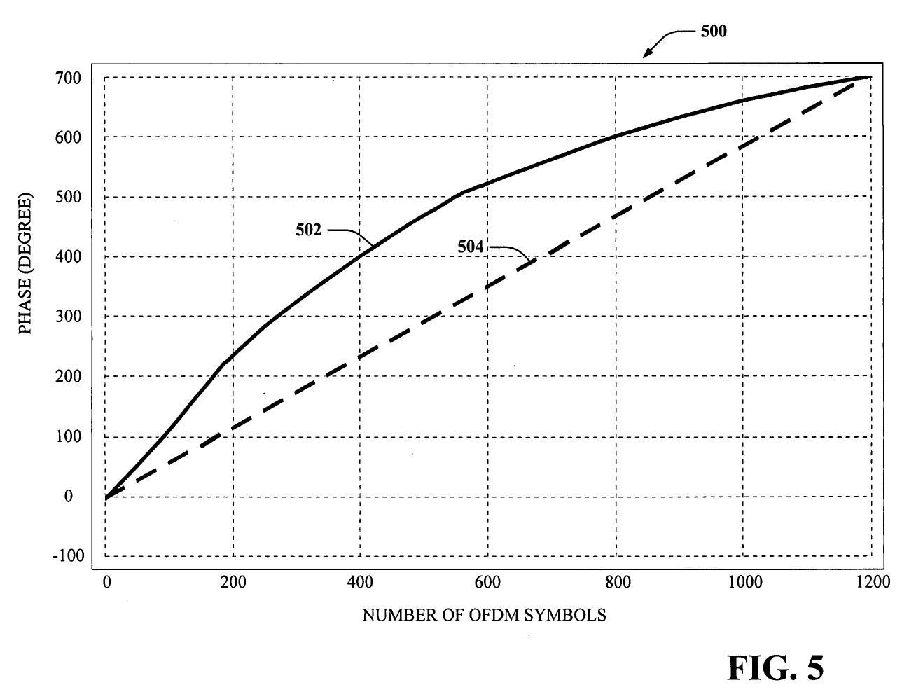

Referring now to FIG. 5, a graphical representation 500 illustrating phase estimation/correction is shown. The graphical representation 500 includes a line 502 indicating an actual phase for a received signal with respect to received symbols over time. Thus, it can be discerned that the phase alters non-linearly over time. Another line 504 indicates a first-order estimation of phase over an entirety of the super frame (shown as 1200 symbols). It is understood, however, that a super frame can include any suitable number of symbols, and that the number 1200 should be considered an example and not limitative of the claimed subject matter. It can be discerned from the graphical representation 500 that use of a linear algorithm for estimation/correction of phase alteration over time is insufficient, as a substantial amount of non-linear noise remains (thereby rendering it difficult to determine transmitter performance).

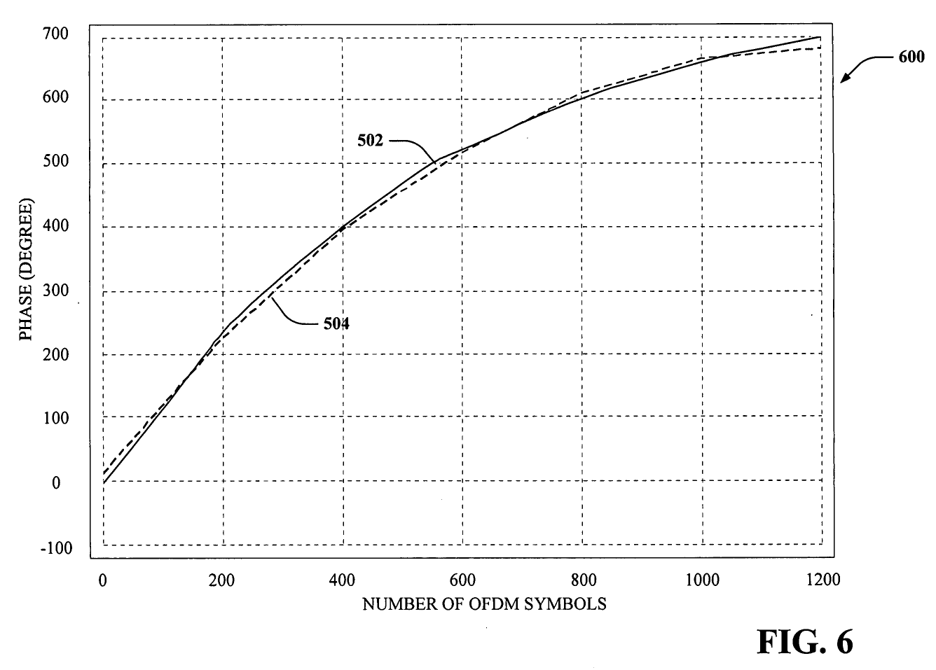

Turning now to FIG. 6, a graphical representation 600 illustrating phase estimation/correction is depicted. A first line 602 again indicates phase of a received signal altering as OFDM symbols are processed. A second line 604 illustrates a second-order estimation of the phase over an entirety of a super frame. While the second-order estimation is more accurate than the first-order approximation, there remains significant discrepancy between actual phase with respect to processed symbols and estimated phase with respect to processed symbols.

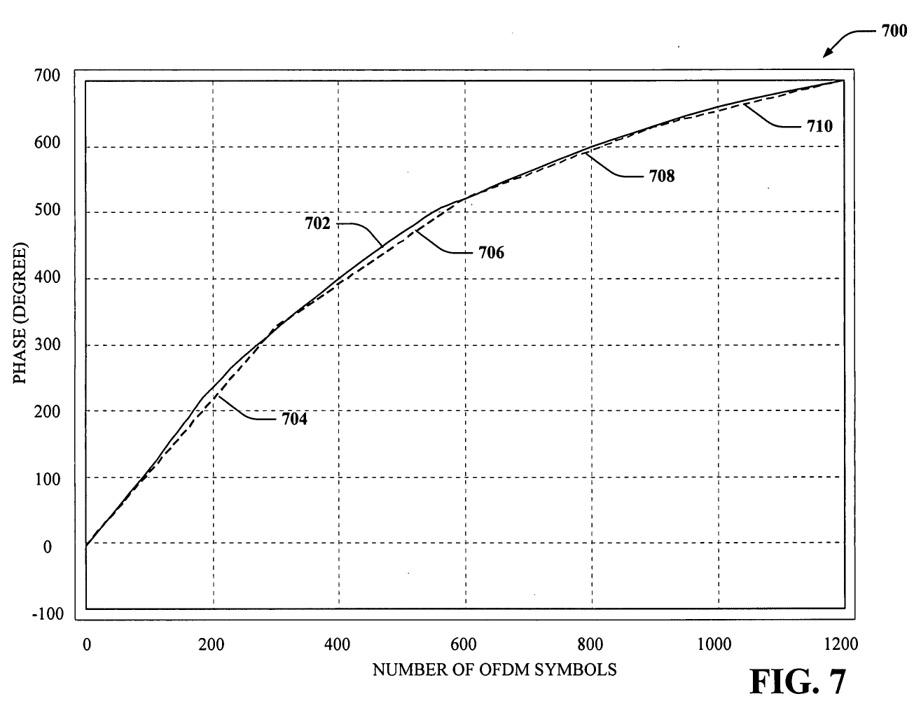

Now referring to FIG. 7, a graphical representation 700 illustrating phase estimation/correction through utilization of segmentation of the super frame is shown. In this example graphical representation 700, the super frame has been partitioned into 4 segments (of 300 OFDM symbols). The representation 700 further illustrates that, upon segmenting, a linear estimation/correction algorithm has been applied. In more detail, a first line 702 represents actual phase with respect to OFDM symbols, and lines 704, 706, 708, and 710 illustrate linear estimates of the four segments. As can be easily ascertained from comparison of FIG. 7 with FIG. 5, the segmented linear estimation is much more proximate to actual phase than the linear estimate over the entirety of the super frame. In other words, a significant portion of nonlinear noise is cancelled while quantization noise is not drastically affected (thereby enabling analysis of quantization noise associated with a transmitter).

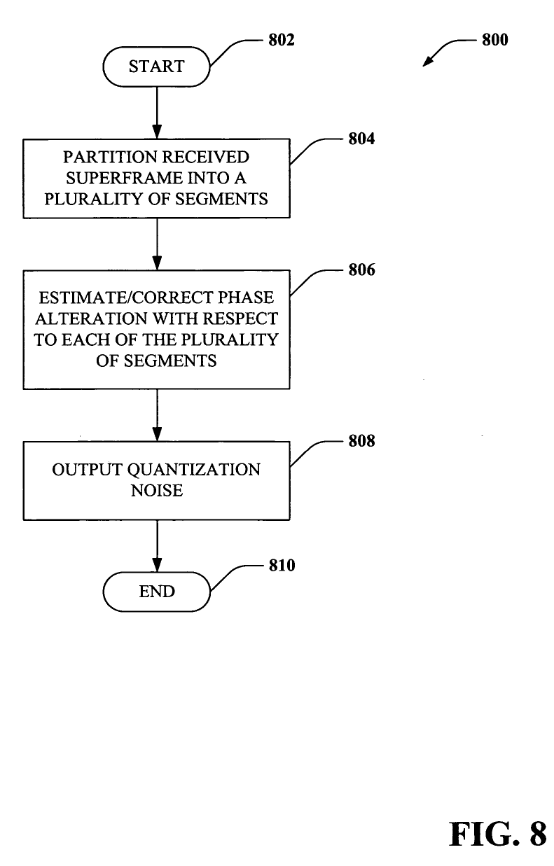

Referring to FIGS. 8-9 and 15-19, methodologies relating to testing FLO transmitter performance are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be utilized to implement a methodology in accordance with the claimed subject matter.

Referring specifically to FIG. 8, a methodology 800 that facilitates analyzing transmitter performance is illustrated. The methodology 800 starts at 802, and at 804 a received super frame is partitioned into a plurality of segments. In an example, a super frame can include a plurality of OFDM symbols, which can be received and processed over a particular period of time. Therefore, segmenting a super frame is consistent with partitioning based upon time. The super frame can include any suitable number of symbols, and such super frame can be segmented into any suitable number of segments. A number of segments should not be too great, however, as white Gaussian noise will be cancelled.

At 806, phase alteration is estimated/corrected with respect to each of the plurality of segments. For instance, phase can be estimated/corrected through utilization of a first order correction algorithm, which can be least squared-based. The first order algorithm, however, need not be least-squared based, but can be any suitable first order algorithm. Additionally or alternatively, phase of at least one segment can be estimated/corrected by way of employment of a least-square based second order phase estimation/correction algorithm. Such an algorithm was described in detail above with respect to FIG. 1. At 808, quantization noise (white Gaussian noise or additive noise) is output. For example, phase correction by way of segmentation enables nonlinear noise to be substantially cancelled without cancelling quantization noise. The amount of quantization noise can be indicative of performance of a FLO transmitter, for instance. The methodology 800 then completes at 810.

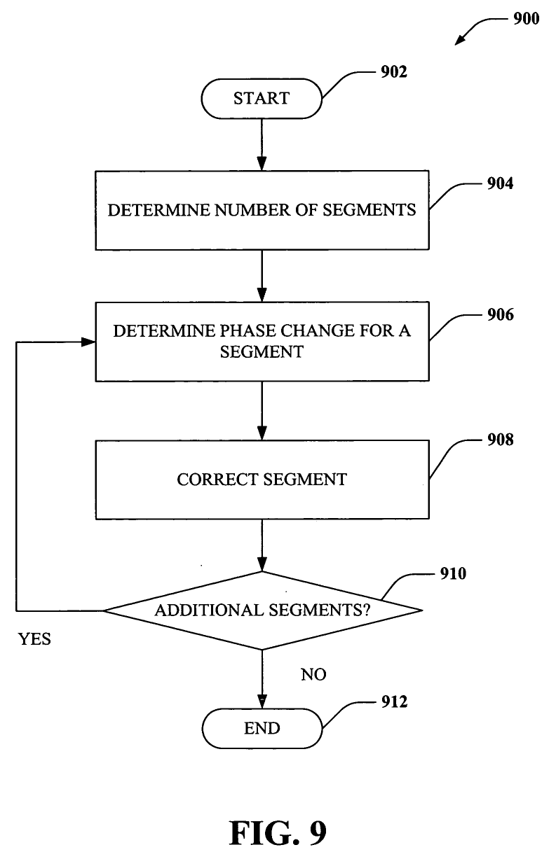

Referring now to FIG. 9, a methodology 900 for correcting frequency offset is illustrated. The received signal including a frequency offset can be written as follows:

$$r ( t ) = {\sum }_{n = 0}^{N - 1} {R}_{n} {ⅇ}^{j ( {ω}_{0} + n {ω}_{s} + Δω ) t}$$

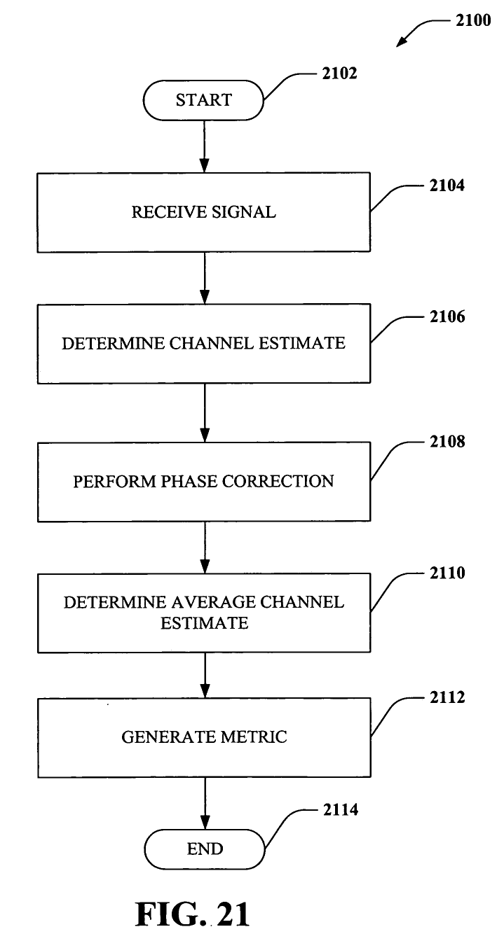

Here Rₙ is the complex amplitude of the nth sub carrier and N is the total number of sub carriers. The frequency of the initial sub carrier is represented by ω₀, ωₛ represents the sub carrier spacing and Δω is the frequency offset. A constant frequency offset will result in a linear phase change with time. A frequency offset that varies linearly with time will result in a parabolic phase change over time. Either a constant or linearly changing frequency offset results in a predictable phase change which can be corrected prior to averaging, as shown in FIG. 21.

A linear phase change can be corrected using a first order phase correction algorithm by calculating the slope of phase change. For example, the phase change can be calculated as follows:

$$\begin{matrix}\frac{ⅆ φ}{ⅆ t} = \frac{1}{{T}_{OFDM}} {\sum }_{l = 0}^{L} {Δφ}_{l + 1} \\ = \frac{{φ}_{L} - {φ}_{0}}{L}\end{matrix}$$

Here, Δφₖ₊₁=φₖ₊₁−φₖ is the phase change of the channel estimation between two adjacent OFDM symbols, φ₀ is the phase of the initial channel estimation, L is the number of OFDM symbols and T_{OFDM} is a period.

A parabolic phase change can be corrected using a second order phase correction with a least square algorithm to determine the parameters, a, b and c, of the parabolic function. The estimated phase can be written as follows:
φₑₛₜ=a·t²+b−t+c
Here, t is time. The estimated phase can be used to correct the estimated channels prior to averaging.

A parabolic phase change can be corrected using a second order phase correction with a least square algorithm to determine the parameters, a, b and c, of the parabolic function. The estimated phase can be written as follows:
φₑₛₜ=a·t²+b·t+c
Here, t is time. The estimated phase can be used to correct the estimated channels prior to averaging.

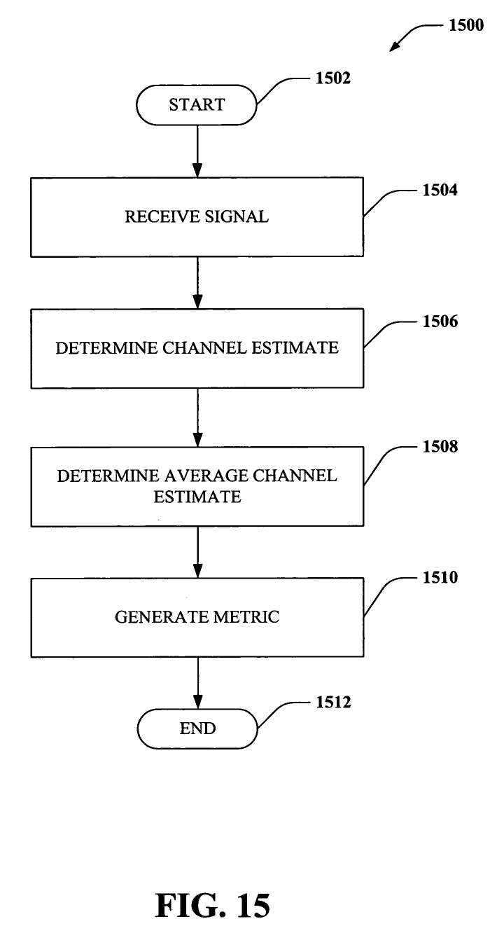

However, the frequency offset is not necessarily constant or linearly varying. Consequently, the phase change is not necessarily linear or parabolic and predictable. One possible solution for correcting for a variable frequency offset includes separating the time duration into segments and then estimating the phase change for each segment. As a result, the estimated noise variance Bₖ described below in FIG. 15 can be modified as follows:

$${B}_{k} = \frac{2}{2 L - N - 1} {\sum }_{l = 1}^{L} {W}_{k , l}^{2}$$

where, Bₖ is noise variance with respect to a sub carrier k, L is a number of OFDM symbols in a super frame, N is the number of segments, l identifies an OFDM symbol, and Wis noise. Such noise variance can be employed in connection with determining MER.

The noise term for each channel of each OFDM symbol derived from the received signal can be decomposed into two orthogonal dimensions: amplitude dimension and phase dimension. The noise term in the amplitude dimension can be considered additive white Gaussian noise. The noise term in the phase direction can be considered the sum of the additive white Gaussian noise (AWGN) and the distortion that comes from the frequency offset. The distortion caused by the frequency offset should be substantially eliminated. However, the component of AWGN in the phase dimension should be substantially maintained.

The methodology 900 starts at 902, and at 904 the number of segments into which the time will be divided is determined. At 906 the phase change due to frequency offset is estimated for a segment. The segment is corrected using either a first or second order correction algorithm at 908. At 910 a determination is made as to whether there are additional segments to correct. If yes, the process returns to 906 to determine the phase correction for the next segment. If no, the process terminates at 912.

In one extreme case, if the variance of the noise in the amplitude dimension is equal to that of the variance of the noise in the phase dimension, maximum number of segments is equal to the number of OFDM symbols being processed. Consequently, the noise in the phase dimension will be eliminated as well as the distortion due to frequency offset. As a result, the true value of MER, which includes the noise in the phase dimension, will be equal to the value of the generated MER minus a constant (e.g., 3.01 dB).

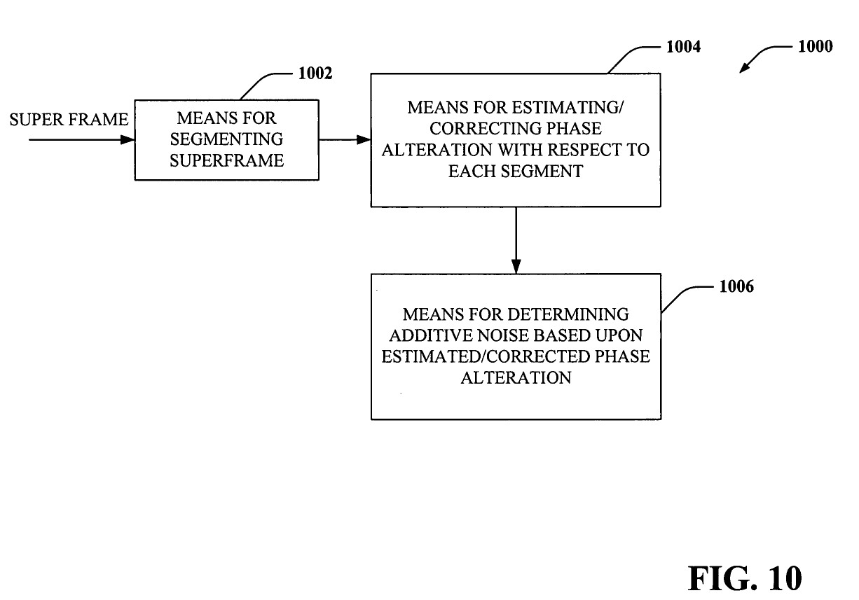

Now referring to FIG. 10, a system 1000 that facilitates analyzing performance of a transmitter is illustrated. The system 1000 includes a means for segmenting a super frame 1002, wherein such means 1002 can include software, hardware, and/or a combination thereof. The means for segmenting the super frame can include times that a segmentation should occur (until an entirety of a super frame is received). System 1000 can additionally include means for estimating/correcting phase alteration with respect to each segment. Again, such means can include software, hardware, or a combination thereof. Means 1004 can include use of a first or second order phase correction algorithm, wherein such algorithms can be least square algorithms. A means 1006 for determining additive noise based upon estimated/corrected phase can also be included within system 1000.

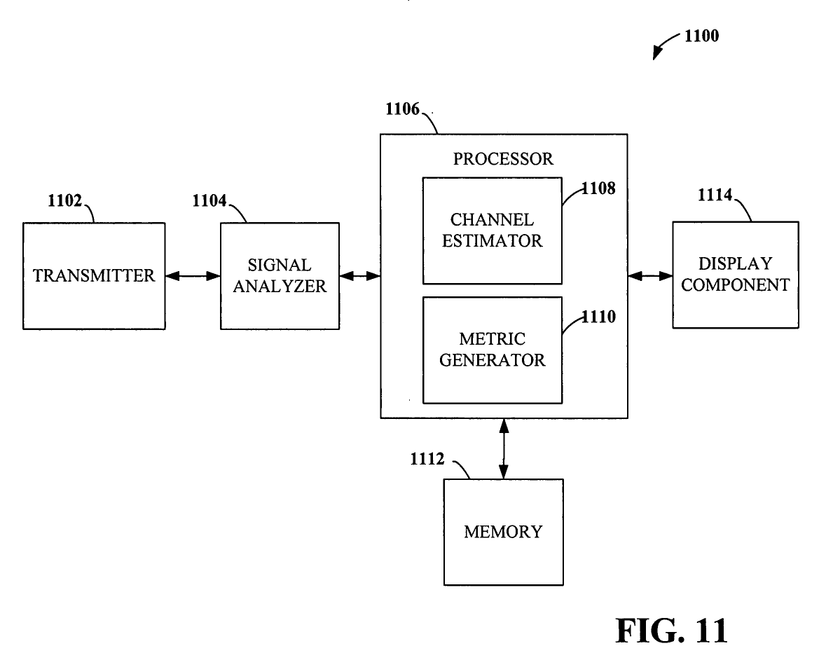

Referring now to FIG. 11, a transmitter evaluation system 1100 in accordance with various aspects presented herein is illustrated. System 1100 can include a signal analyzer 1104 that can be used to sample a signal generated by a transmitter 1102. By using signal analyzer 1104 rather than a receiver to receive the signal, system 1100 can eliminate the receiver as a possible source of additional noise and distortion. System 1100 can also include a processor 1106 capable of processing the signal captured by signal analyzer 1104 and generating metrics to evaluate the performance of transmitter 1102. Processor 1106 can include a channel estimator 1108 that can be used to generate frequency domain channel estimates for each sub carrier. Processor 1106 can also include a metric generator 1110 that generates a metric, such as the modulation error ratio (MER), to evaluate performance of transmitter 1102. The metric produced by metric generator 1110 can based upon the frequency domain channel estimates produced by channel estimator 1108. System 1100 can also include a memory 1112 connected to processor 1106 that data relating to transmitter performance evaluation (e.g., symbol data and metric data). In addition, system 1100 can include a display component 1114 to allow a user to monitor transmitter performance through visual feedback generated by processor 1106.

Processor 1106 can provide various types of user interfaces for display component 1112. For example, processor 1106 can provide a graphical user interface (GUI), a command line interface and the like. For example, a GUI can be rendered that provides a user with a region to view transmitter information. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed.

In an example, a command line interface can be employed. For example, the command line interface can prompt (e.g., by a text message on a display and an audio tone) the user for information by providing a text message or alert the user that the transmitter performance is outside of predetermined bounds. It is to be appreciated that the command line interface can be employed in connection with a GUI and/or application program interface (API). In addition, the command line interface can be employed in connection with hardware (e.g., video cards) and/or displays (e.g., black and white, and EGA) with limited graphic support, and/or low bandwidth communication channels.

In addition, the evaluation system can generate an alert to notify users if the transmitter performance is outside of an acceptable range. The alert can be audio, visual or any other form intended to attract the attention of a user. The evaluation system can include a predetermined set of values indicating the boundaries of the acceptable range. Alternatively, users may dynamically determine the boundaries. In addition, the evaluation system can generate an alert based upon a change in transmitter performance.

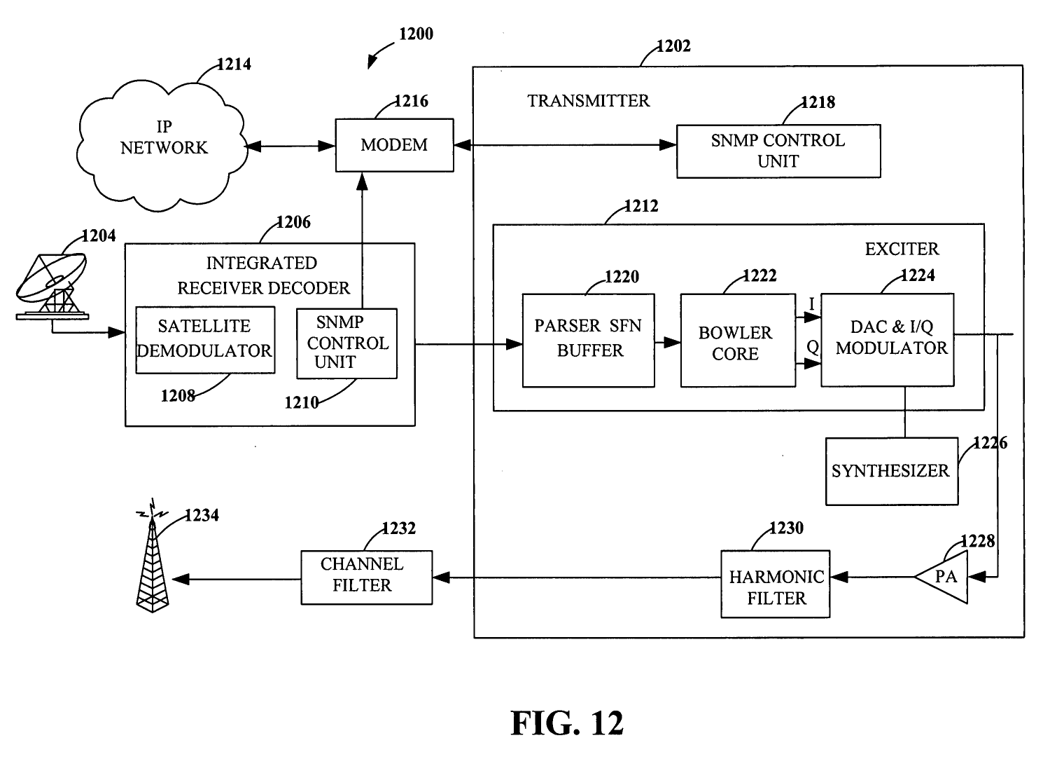

FIG. 12 is an illustration of a wireless communication system 1200. System 1200 includes a transmitter 1202 that can receive data for transmission from a communication satellite system 1204. Signals from satellite system 1204 can be propagated through an integrated receiver decoder 1206 that can include a satellite demodulator 1208 and a simple network management protocol (SNMP) control unit 1210. Signal data from integrated receiver decoder 1206 can be input into an exciter 1212 within transmitter 1202. In addition, transmitter 1202 can be connected to an Internet provider (IP) network 1214 through a modem 1216. Modem 1216 can be connected to a SNMP control unit 1218 within transmitter 1202. Exciter 1212 can include a parser and single frequency network (SFN) buffer 1220, a bowler core 1222 and a digital to analog converter (DAC) and I/Q modulator 1224. Signal data from satellite system 1204 can be parsed and stored in parser and SFN buffer 1220. Bowler core 1222 generates complex number representing the signal data, passing the signal data to DAC and I/Q modulator 1224 as in-phase (I) and quadrature (Q) components. DAC and I/Q modulator 1224 can utilize a synthesizer 1226 to process the signal data and produce an analog, radio frequency (RF) signal. After the data is converted to analog, the resulting RF signal data can be passed to a power amplifier 1228 and through a harmonic filter 1230. In addition, the data can be passed through a channel filter 1232 prior to transmission by antenna 1234.

To evaluate transmitter performance, the RF signal data produced by exciter 1212 can be monitored. Possible sources of transmitter error or noise include up-sampling, digital to analog conversion and RF conversion. The signal data can be sampled at the output of the exciter and at the output of the channel filter, such that the RF signal can be sampled either before or after power amplification and filtering. If the signal is sampled after amplification, the signal should be corrected for power amplification nonlinearity.

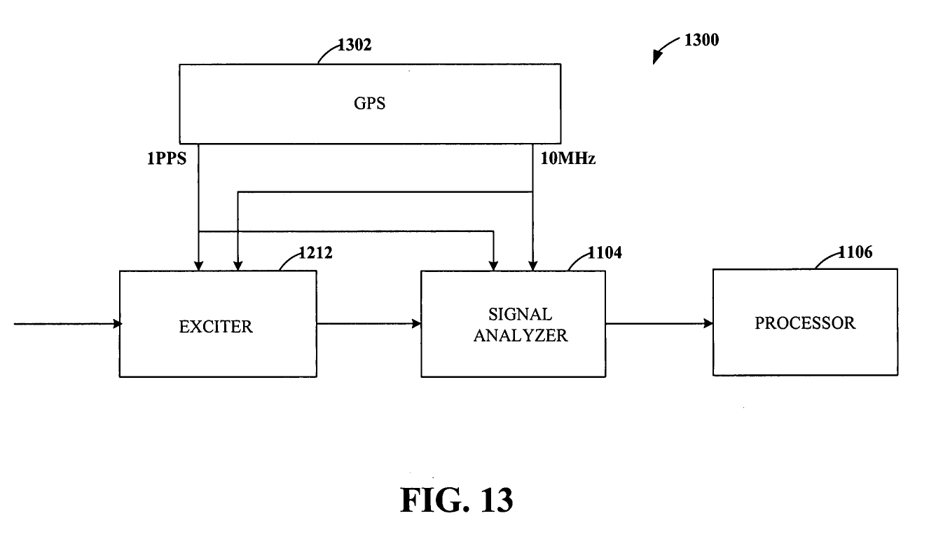

Referring now to FIG. 13, a transmitter evaluation system 1300 connected to transmitter system exciter 1212 is illustrated. Signals from a global positioning system (GPS) receiver 1302 can be used to synchronize transmitter exciter 1212 and signal analyzer 1104. An external 10 Megahertz clock from GPS receiver 1302 can be fed into both exciter 1212 and signal analyzer 1104 to act as a common clock reference. To synchronize the start of sampling by signal analyzer 1104 to the beginning of the super frame of the RF signal data output by exciter 1212, GPS 1302 can transmit a 1 pulse per second (PPS) signal to exciter 1212 for synchronization and to signal analyzer 1104 to trigger the start of sampling. Signal analyzer 1104 can generate digital samples of exciter analog output waveform at a rate that is synchronous to the baseband chip rate of the transmitted signal. Sampled data is then fed into processor 1106. Processor 1106 can be implemented using a general-purpose processor or a processor dedicated to analyzing transmitter data. Use of a general-purpose processor can reduce the cost of transmitter evaluation system 1300. Signal analyzer 1104 can be configured to run in floating point mode to avoid quantization noise.

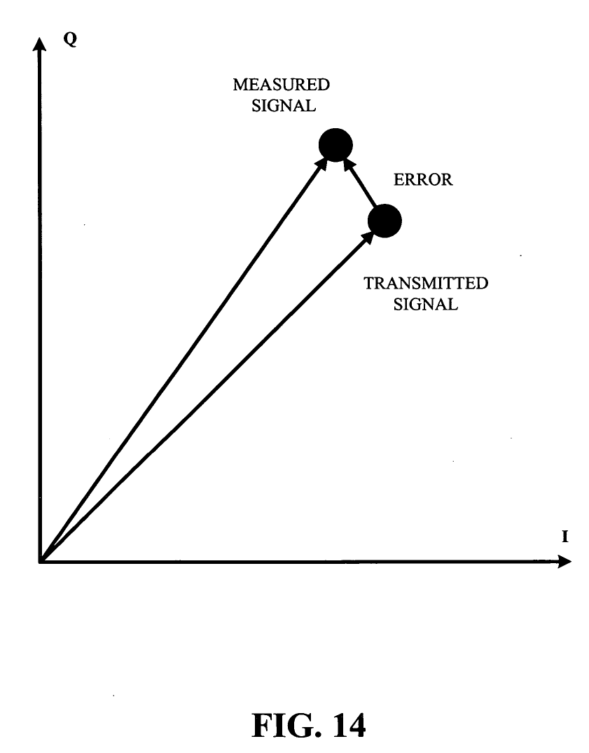

Referring now to FIG. 14, a constellation diagram illustrating the difference between measured or received signal and transmitted signal is shown. The axes of the constellation diagram represent the real and imaginary components of complex numbers, referred to as the in phase or I-axis and the quadrature or Q-axis. The vector between the measured signal constellation point and the transmitted signal constellation point represents the error, which can include digital to analog conversion inaccuracies, power amplifier nonlinearities, in-band amplitude ripple, transmitter IFFT quantization error and the like.

The transmitter evaluation system can generate one or more metrics to evaluate the performance of the transmitter. Metrics generated by processor include, but are not limited to, modulation error ratio (MER), group delay or channel frequency response. In particular, MER measures the cumulative impact of flaws within the transmitter. MER for a sub carrier is equivalent to signal to noise ratio (SNR) for a sub carrier. MER can be generated using the following equation:

$$MER ( dB ) = 10 log \frac{\frac{1}{N} {\sum }_{1}^{N} ( {I}^{2} + {Q}^{2} )}{\frac{1}{N} {\sum }_{1}^{N} ( Δ {I}^{2} + Δ {Q}^{2} )}$$

Here, I is the in phase value of the measured constellation point, Q is the quadrature value of the measured constellation point and N is the number of sub carriers. ΔI is the difference between the in phase values of the transmitted and measured signals and ΔQ is the difference between the quadrature values of the transmitted and measured signals.

Referring now to FIG. 15, a methodology 1500 for processing RF signal data received from a transmitter and evaluating transmitter performance is illustrated. Typically, transmitters broadcast real time scheduled data streams in super frames. A super frame can include a group of frames (e.g., 16 frames) where a frame is a logical unit of data.

The methodology 1500 starts at 1502, and at 1504, the signal is received or sampled from the transmitter. The received signal can be written as follows:
Yₖ=Hₖ·Pₖ+Nₖ
Here, Hₖ is the channel of a sub carrier, k. A known modulation symbol, Pₖ, can be transmitted on the sub carrier k. Complex additive white Gaussian noise (AWGN) with a zero mean and a variance of σ² can be represented by Nₖ.

The possible modulation types for the sub carriers can include, but are not limited to, quadrature phase-shift keying (QPSK), layered QPSK with an energy ratio of 6.25 (ER6.25), 16 QAM (quadrature amplitude modulation) and layered QPSK with energy ratio of 4.0 (ER4). When analyzed based upon the constellation point of view, the layered QPSK with energy ratio 4.0 is identical to that of 16 QAM. Constellation point of view, as used herein, refers to utilization of constellation diagrams to represent digital modulation schemes in the complex plane. Modulation symbols can be represented as constellation points on a constellation diagram.

An initial frequency domain channel estimate for a sub carrier can be determined at 1506. An initial channel estimate for each sub carrier can be obtained by dividing the received signal Yₖ by a known symbol, Pₖ. Selected symbols can be transmitted, such that the symbols are known for the purpose of performance evaluation. The initial frequency domain channel estimate for each sub carrier, k, of every OFDM symbol, l, within a super frame, can be represented as follows:

$$\begin{matrix}{Z}_{k , l} = {Y}_{k , l} / {P}_{k , l} \\ = {H}_{k , l} + \frac{{N}_{k , l} \cdot {P}_{k , l}^{*}}{{\vert {P}_{k , l} \vert}^{2}}\end{matrix}$$

Here, Z_{k,l} is an initial channel estimate for sub carrier k and OFDM symbol l.

An Average channel estimate is determined at 1508. The channel estimate Z_{k,l} of sub carrier can be refined by averaging over the entire super frame, such that:

$${\hat{H}}_{k} = {H}_{k} + \frac{1}{L} {\sum }_{l = 0}^{L - 1} \frac{{N}_{k , l} \cdot {P}_{k , l}^{*}}{{\vert {P}_{k , l} \vert}^{2}}$$

Here, k is the OFDM symbol index and L is the number of the OFDM symbols in the super frame (e.g., 1188 symbols). Since the variance of the average channel estimate is smaller than the variance of the initial channel estimate, the variance of the average channel estimate can be used to approximate the channel gain of the sub carrier during metric generation.

At 1510, a metric for evaluating the transmitter performance is generated. For example, the MER for a sub carrier k can be generated. Assuming that the transmitted symbols are known, noise variance can be estimated as follows:

$$\begin{matrix}{W}_{k , m} = {Y}_{k , m} - {\hat{H}}_{k} \cdot {X}_{k , m} \\ = {N}_{k , m} - \frac{1}{L} {\sum }_{l = 0}^{L - 1} \frac{{N}_{k , l} \cdot {X}_{k , l}^{*}}{{\vert {X}_{k , l} \vert}^{2}} \cdot {X}_{k , m}\end{matrix}$$

Here, the X_{k,m} represents the transmitted symbol for sub carrier k. It can be shown that the in-phase and quadrature components of the noise, Wₖ, is approximately:

$$N ( 0 , ( 1 - \frac{1}{L} ) \frac{{σ}^{2}}{2} )$$

if, random variable Bₖ is the estimated noise variance, such that:

$${B}_{k} = \frac{1}{L - 1} {\sum }_{l = 1}^{L} {W}_{k , l}^{2}$$

$$and \text{:}$$

$$E ( {B}_{k} ) = \frac{L}{L - 1} E ( {W}_{k}^{2} ) = {σ}^{2}$$

The MER can be determined based upon the average channel estimate for the sub carrier, the symbol transmitted on the sub carrier and the signal received for the sub carrier. A MER can be calculated based upon the following example equation:

$${MER}_{k} = \frac{E {\vert {H}_{k} \cdot {P}_{k} \vert}^{2}}{E {\vert {Y}_{k} - {H}_{k} \cdot {P}_{k} \vert}^{2}} = \frac{E {\vert {H}_{k} \vert}^{2} \cdot E {\vert {P}_{k} \vert}^{2}}{E {\vert {N}_{k} \vert}^{2}} \approx \frac{E {\vert {\hat{H}}_{k} \vert}^{2} \cdot E {\vert {P}_{k} \vert}^{2}}{E ( {B}_{k} )}$$

Here, Ĥₖ is the average channel estimate for sub carrier k, Pₖ is the symbol transmitted on the sub carrier, Yₖ is the received signal and Nₖ is the AWGN. In addition, MER can be calculated by averaging over all of the sub carriers.

Additional metrics can be generated to evaluate transmitter performance. For example, metrics can include frequency response and group delay. Group delay of sub carrier k can be calculated as follows:

$${GD}_{k} = - \frac{ⅆ θ}{ⅆ ω} {\vert}_{k} = - \frac{1}{2 π} E ( \frac{{Δφ}_{k , k - 1}}{Δ {f}_{k , k - 1}} ) .$$

Here, k=1, . . . , 4000; Δφ_{k,k-1} is the phase difference between sub carriers k and k−1; and Δf_{k,k-1} is the frequency difference between sub carriers k and k−1. The methodology 1500 then completes at 1512.

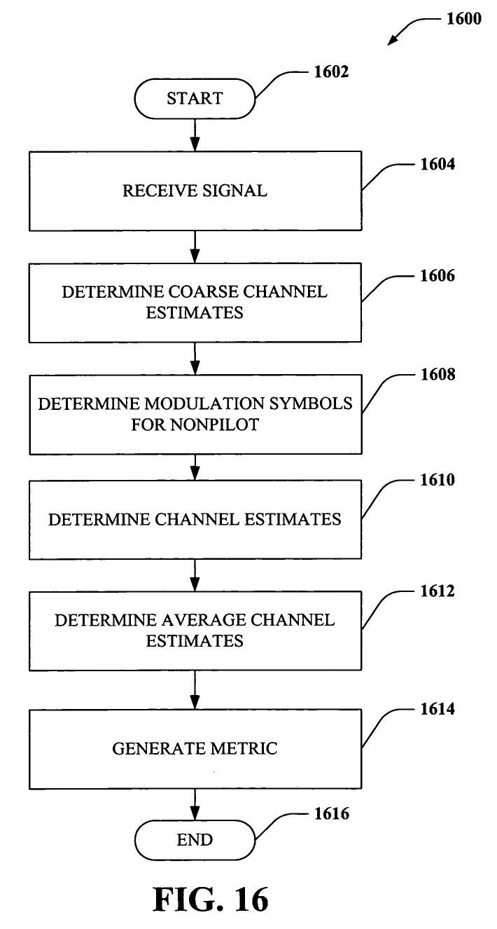

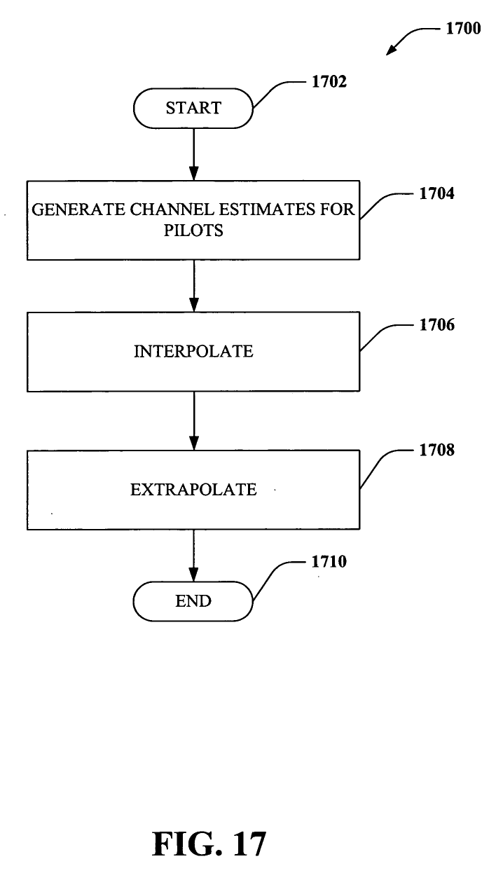

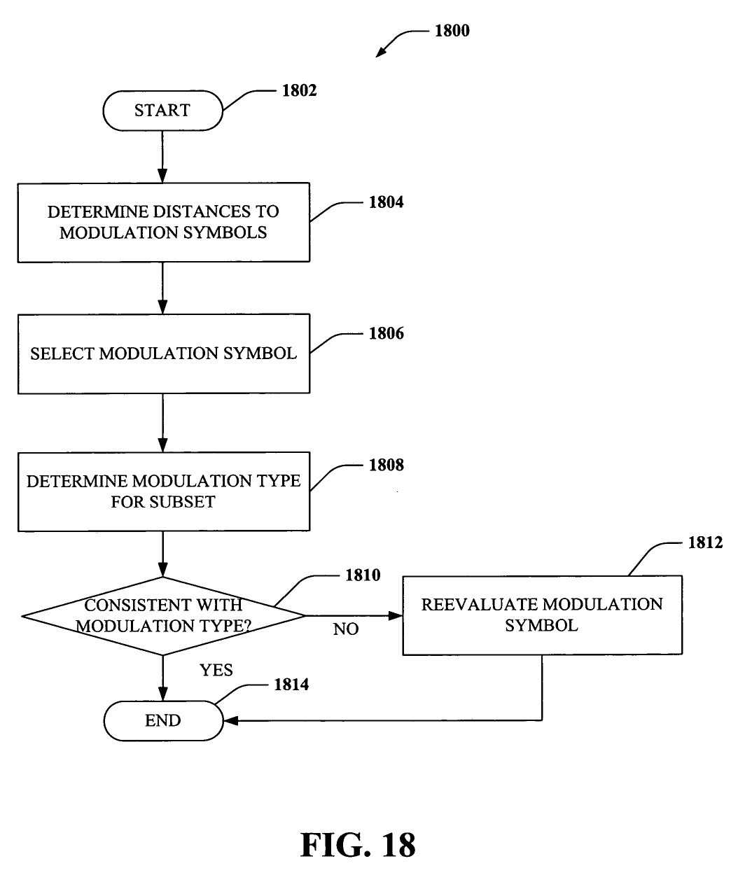

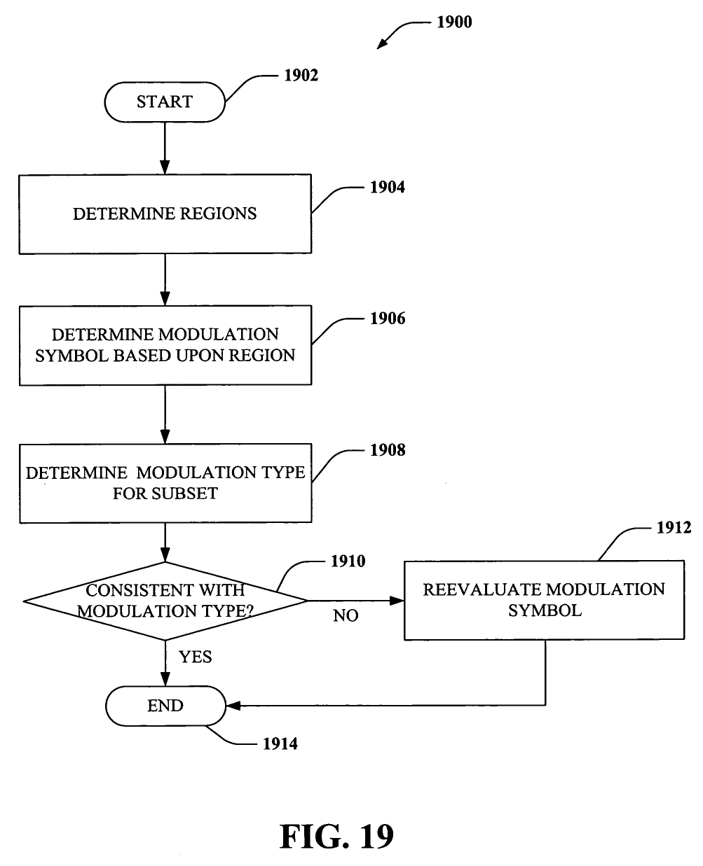

Referring now to FIG. 16, a methodology 1600 for evaluating a transmitter where the transmitted symbols are unknown is illustrated. The modulation symbols (e.g., QPSK or 16 QAM symbols) are unknown when real time data streams are transmitted. However, the pilot symbols are known. The methodology 1600 starts at 1602, and at 1604, a signal is received. A coarse initial channel estimation for the sub carriers can be generated at 1606. The coarse initial channel estimation can be performed using the known pilot symbols and linear interpolation and extrapolation, as described with respect to FIG. 17 below. At 1608, the modulation symbols for the sub carriers are determined. The modulation symbols can be determined using a constellation diagram as described below with respect to FIGS. 18 and 19. The symbols can be selected based upon the distance between the received signal constellation point and the modulation symbol corresponding to the closest symbol constellation point. Symbol selection is described in further detail below. At 1610, an initial frequency domain channel estimate for each sub carrier can be determined. An initial channel estimate for each sub carrier can be obtained by dividing the received signal by the modulation symbol.

At 1612, the channel estimates are averaged over the super frame to increase accuracy. The average channel estimate can be determined using the coarse modulation type for a. subset of the sub carriers having a consistent modulation type. A half-interlace is used herein as an example of a subset of sub carriers having a consistent modulation type. However, in the systems and methods discussed herein, the subset of sub carriers having a consistent modulation type is not limited to a half-interlace. Errors in modulation symbol selection can be avoided by checking the modulation symbol for a sub carrier against the modulation type for the subset of sub carriers. The modulation type for the subset of sub carriers can be determined at 1808. At 1810, it is determined whether the modulation symbol is consistent with the modulation type. If yes, the process terminates. If no, the modulation symbol is reevaluated and a modulation symbol consistent with the modulation type is selected at 1812.

Typically, the modulation type remains consistent during a half interlace. In general, the modulation type does not change within an interlace due to constraints in the FLO protocol. An interlace, as used herein is a set of sub carriers (e.g., 500 sub carriers). Consequently, a half-interlace is one half of an interlace (e.g., 250 sub carriers). However, for rate-⅔ layered modulation, the modulation type can be switched to QPSK within an interlace when operating in base-layer only mode. Even under these conditions the modulation type within each half-interlace remains constant. Therefore, the modulation type for each half-interlace can be determined using majority voting. To determine the modulation type for a half-interlace or any other subset of sub carriers having a consistent modulation type, the modulation symbol, and consequently the modulation type, can be determined for each sub carrier within the subset. A majority vote based on the modulation type corresponding to each sub carrier can be used to determine the modulation type for the subset. For example, for a half-interlace including 250 sub carriers, the modulation type for 198 of the sub carriers could be consistent with the QPSK modulation type and the modulation symbols for the remaining 52 sub carriers could be consistent with the 16 QAM modulation type. Since the majority of the sub carriers are detected as QPSK, QPSK would be selected as the modulation type for the half-interlace. The 52 sub carriers that were associated with the 16 QAM modulation type can be reevaluated and reassigned to QPSK modulation symbols based upon their location in the constellation diagram. Comparing the modulation symbol to the modulation type for the half-interlace and reevaluating modulation symbols as needed increases the accuracy of modulation symbol selection. The methodology 1800 completes at 1814.

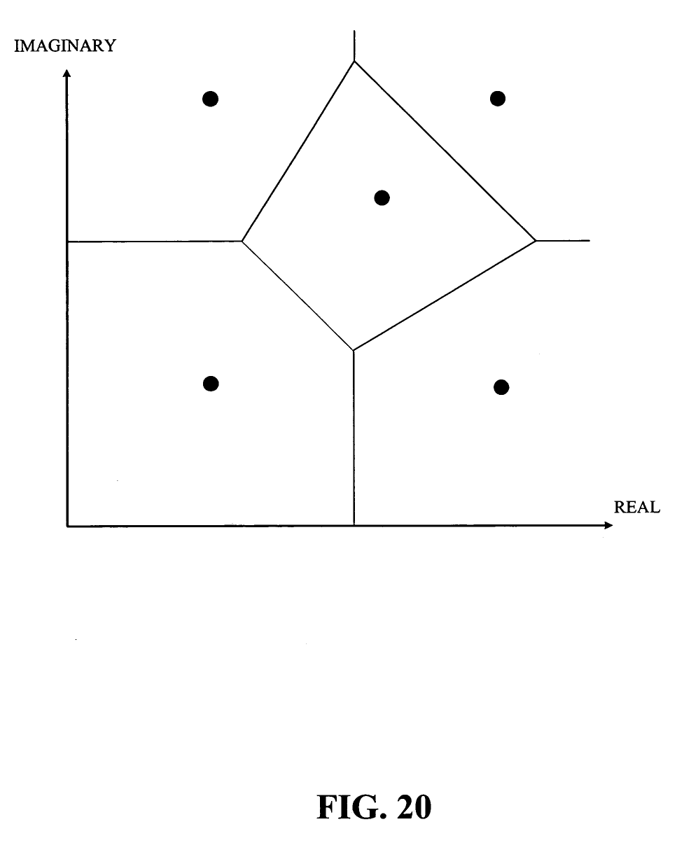

Referring now to FIG. 19, a methodology 1900 for determining modulation symbols is illustrated. The methodology 1900 starts at 1902, and at 1904, a constellation diagram including constellation points representing various modulation symbols is divided into a series of regions. Each region is associated with a modulation symbol constellation point. Regions are defined such that every point in each region has the property that the distance of such a point to the constellation point of the region is less than or equal to the distance between such point to the constellation point of any other region. A set of regions covering the first quadrant of the constellation diagram is illustrated in FIG. 20. At 1906, the region in which the received signal constellation point is located is determined. The modulation symbol corresponding to the region in which the received signal constellation point is located is selected as the modulation symbol. The modulation symbol can be checked against the modulation type for a subset of sub carriers having a consistent modulation type (e.g., a half-interlace). The modulation type for the subset of sub carriers can be determined at 1908. At 1910, it is determined whether the modulation symbol is consistent with the modulation type. If yes, the process terminates. If no, the modulation symbol is reevaluated and a modulation symbol consistent with the modulation type is selected at 1912.

The transmitter evaluation systems and methods described herein should also include phase correction, intended to reduce or eliminate error or distortions caused by time frequency offsets. If phase correction is not performed, the channel estimate average can be inaccurate and consequently, the evaluation metrics may be incorrect. Typically, phase correction can be performed prior to the averaging of the channel estimates to correct for phase ramp due to frequency offsets. The methodology 1900 completes at 1914.

Referring now to FIG. 21, a methodology 2100 for evaluating a transmitter using phase correction is illustrated. The methodology 2100 starts at 2102, and at 2104 a signal is received from the transmitter. Channel estimates for sub carriers can be determined at 2106. The channel estimates can be determined using known symbols or unknown symbols. At 2108, phase correction can be performed. After phase correction, the average channel estimate can be determined at 2110. A metric for evaluating transmitter performance can be generated at 2112. For example, the MER for the sub carrier can be determined based upon the channel estimate. The methodology 2100 then completes at 2114.

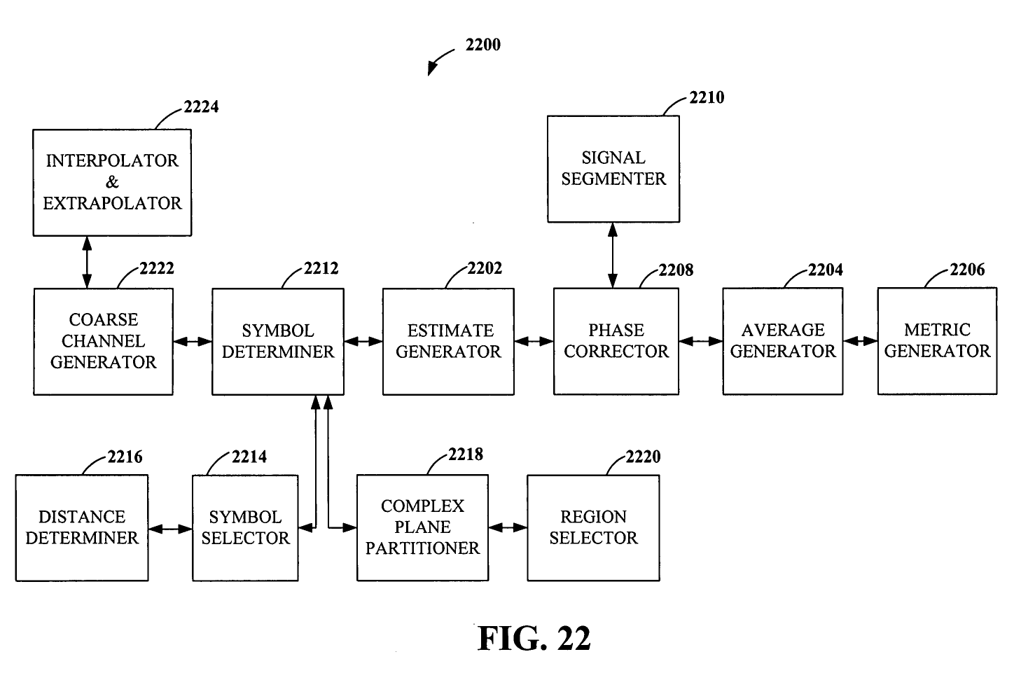

Referring now to FIG. 22, a system 2200 for evaluating transmitter performance in a wireless communication environment in accordance with one or more aspects presented herein is illustrated. System 2200 includes a channel estimate generator 2202 that generates frequency domain channel estimates for sub carriers, an average generator 2204 that calculates the average channel estimate for a sub carrier and a metric generator 2206 that generates a metric, such as MER, used to evaluate transmitter performance. System 2200 can also include a phase corrector 2208 that corrects for phase ramp caused by frequency offset. The signal may be separated into segments by a signal segmentor 2210 for phase correction. In addition, system 2200 can include a symbol determiner 2212 that determines modulation symbols for the sub carriers. The symbols may be selected by a symbol selector 2214 based upon the distance between the received signal and modulation symbols in a complex plane as determined by a distance determiner 2216. Alternatively, the complex plane can be partitioned into regions by a complex plane partitioner 2218 and the region in which the received signal is located can be selected by a region selector 2220 and used to determine the symbol. Furthermore, system 2200 can include a coarse channel generator 2222 that generates coarse channel estimates. An interpolator and extrapolator 2224 can be used to generate the coarse channel estimates.

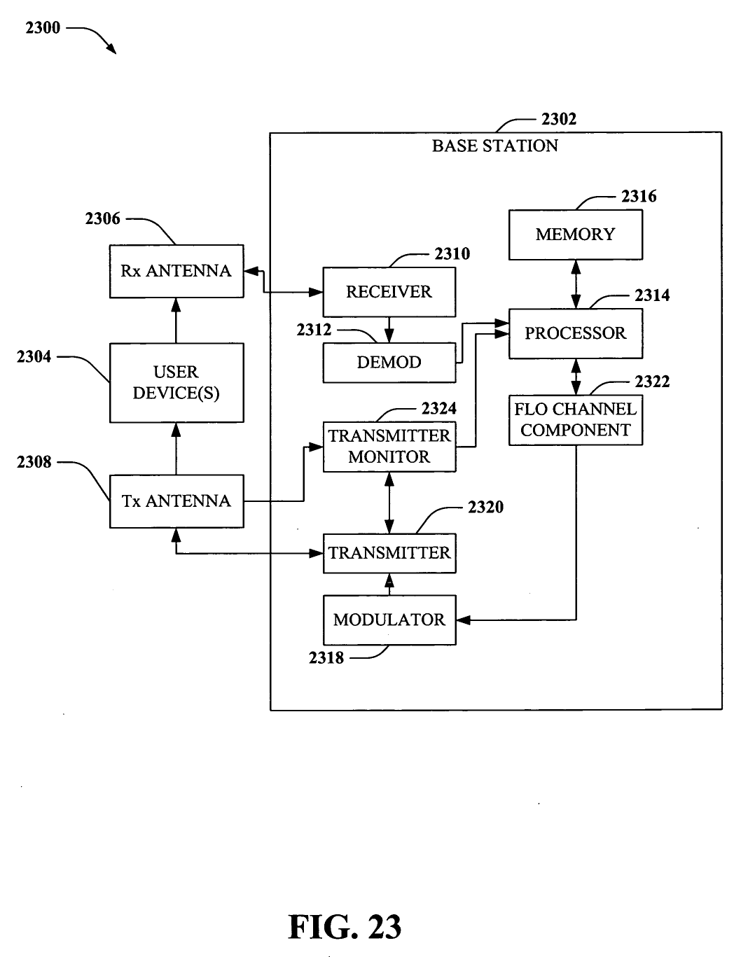

FIG. 23 is an illustration of a system 2300 that provides for monitoring transmitter performance in a communication environment. System 2300 comprises a base station 2302 with a receiver 2310 that receives signal(s) from one or more user devices 2304 via one or more receive antennas 2306, and transmits to the one or more user devices 2304 through one or more transmit antennas 2308. In one or more embodiments, receive antennas 2306 and transmit antennas 2308 can be implemented using a single set of antennas. Receiver 2310 can receive information from receive antennas 2306 and is operatively associated with a demodulator 2312 that demodulates received information. Receiver 2310 can be, for example, a Rake receiver (e.g., a technique that individually processes multi-path signal components using a plurality of baseband correlators, . . . ), an MMSE-based receiver, or some other suitable receiver for separating out user devices assigned thereto, as will be appreciated by one skilled in the art. According to various aspects, multiple receivers can be employed (e.g., one per receive antenna), and such receivers can communicate with each other to provide improved estimates of user data. Demodulated symbols are analyzed by a processor 2314. Processor 2314 can be a processor dedicated to analyzing information received by receiver component 2314 and/or generating information for transmission by a transmitter 2314. Processor 2314 can be a processor that controls one or more components of base station 2302, and/or a processor that analyzes information received by receiver 2310, generates information for transmission by a transmitter 2320, and controls one or more components of base station 2302. Receiver output for each antenna can be jointly processed by receiver 2310 and/or processor 2314. A modulator 2318 can multiplex the signal for transmission by a transmitter 2320 through transmit antennas 2308 to user devices 2304. Processor 2314 can be coupled to a FLO channel component 2322 that can facilitate processing FLO information associated with one or more respective user devices 2304.

Base station 2302 can also include a transmitter monitor 2324. Transmitter monitor 2324 can sample transmitter output and/or transmitter antenna output and evaluate the performance of transmitter 2320. Transmitter monitor 2324 can be coupled to processor 2314. Alternatively, transmitter monitor 2324 can include a separate processor for processing transmitter output. In addition, transmitter monitor 2324 may be independent of base station 2302.

Base station 2302 can additionally comprise memory 2316 that is operatively coupled to processor 2314 and that can store information related to constellation regions and/or any other suitable information related to performing the various actions and functions set forth herein. It will be appreciated that the data store (e.g., memories) components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1516 of the subject systems and methods is intended to comprise, without being limited to, these and any other suitable types of memory.

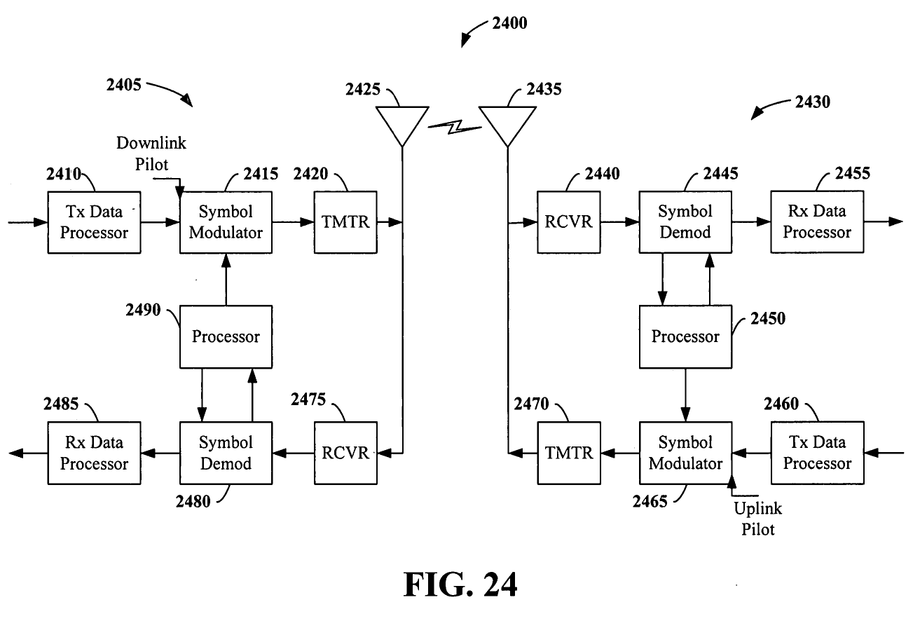

FIG. 24 shows an example wireless communication system 2400. The wireless communication system 2400 depicts one base station and one user device for sake of brevity. However, it is to be appreciated that the system can include more than one base station and/or more than one user device, wherein additional base stations and/or user devices can be substantially similar or different from the exemplary base station and user device described below. In addition, it is to be appreciated that the base station and/or the user device can employ the systems and/or methods described herein.

Referring now to FIG. 24, on a downlink, at access point 2405, a transmit (TX) data processor 2410 receives, formats, codes, interleaves, and modulates (or symbol maps) traffic data and provides modulation symbols (“data symbols”). A symbol modulator 2415 receives and processes the data symbols and pilot symbols and provides a stream of symbols. Symbol modulator 2415 multiplexes data and pilot symbols and provides them to a transmitter unit (TMTR) 2420. Each transmit symbol may be a data symbol, a pilot symbol, or a signal value of zero. The pilot symbols may be sent continuously in each symbol period. The pilot symbols can be frequency division multiplexed (FDM), orthogonal frequency division multiplexed (OFDM), time division multiplexed (TDM), frequency division multiplexed (FDM), or code division multiplexed (CDM).

TMTR 2420 receives and converts the stream of symbols into one or more analog signals and further conditions (e.g., amplifies, filters, and frequency upconverts) the analog signals to generate a downlink signal suitable for transmission over the wireless channel. The downlink signal is then transmitted through an antenna 2425 to the user devices. At user device 2430, an antenna 2435 receives the downlink signal and provides a received signal to a receiver unit (RCVR) 2440. Receiver unit 2440 conditions (e.g., filters, amplifies, and frequency downconverts) the received signal and digitizes the conditioned signal to obtain samples. A symbol demodulator 2445 demodulates and provides received pilot symbols to a processor 2450 for channel estimation. Symbol demodulator 2445 further receives a frequency response estimate for the downlink from processor 2450, performs data demodulation on the received data symbols to obtain data symbol estimates (which are estimates of the transmitted data symbols), and provides the data symbol estimates to an RX data processor 2455, which demodulates (e.g., symbol demaps), deinterleaves, and decodes the data symbol estimates to recover the transmitted traffic data. The processing by symbol demodulator 2445 and RX data processor 2455 is complementary to the processing by symbol modulator 2415 and TX data processor 2410, respectively, at access point 2405.

On the uplink, a TX data processor 2460 processes traffic data and provides data symbols. A symbol modulator 2465 receives and multiplexes the data symbols with pilot symbols, performs modulation, and provides a stream of symbols. A transmitter unit 2470 then receives and processes the stream of symbols to generate an uplink signal, which is transmitted by the antenna 2435 to the access point 2405.

At access point 2405, the uplink signal from user device 2430 is received by the antenna 2425 and processed by a receiver unit 2475 to obtain samples. A symbol demodulator 2480 then processes the samples and provides received pilot symbols and data symbol estimates for the uplink. An RX data processor 2485 processes the data symbol estimates to recover the traffic data transmitted by user device 2430. A processor 2490 performs channel estimation for each active user device transmitting on the uplink. Multiple user devices may transmit pilot concurrently on the uplink on their respective assigned sets of pilot subcarriers, where the pilot subcarrier sets may be interlaced.

Processors 2490 and 2450 direct (e.g., control, coordinate, manage, etc.) operation at access point 2405 and user device 2430, respectively. Respective processors 2490 and 2450 can be associated with memory units (not shown) that store program codes and data. Processors 2490 and 2450 can utilize any of the methodologies described herein. Respective Processors 2490 and 2450 can also perform computations to derive frequency and impulse response estimates for the uplink and downlink, respectively.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor via various means as is known in the art.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for analyzing performance of a transmitter, comprising:
partitioning a super frame into a plurality of segments;
estimating and correcting phase with respect to at least one of the plurality of segments; and
determining additive noise with respect to the at least one segment.

2. The method of claim 1, wherein the transmitter is a FLO transmitter.

3. The method of claim 1, further comprising estimating and correcting phase alteration with respect to the at least on segment through employment of a first order phase correction algorithm.

4. The method of claim 3, the first order phase correction algorithm is of the form:
$$\frac{ⅆ φ}{ⅆ t} = \frac{1}{{T}_{OFDM}} {\sum }_{l = 0}^{L} {Δφ}_{l + 1} = \frac{{φ}_{L} - {φ}_{0}}{L} ,$$
where Δφₖ₊₁=φₖ₊₁−φₖ is the phase change of a channel estimation of two adjacent OFDM symbols, and T_{OFDM} is a time period.

5. The method of claim 3, wherein the first order phase correction algorithm is a least square based first order phase correction algorithm.

6. The method of claim 5, the least square based first order phase correction algorithm is of the following form:
φₑₛₜ=a·t+b,
where a and b are determined parameters and t is time.

7. The method of claim 1, further comprising estimating and correcting phase alteration with respect to the at least one segment through employment of a second order phase correction algorithm.

8. The method of claim 7, wherein the second order phase correction algorithm is a least square based second order phase correction algorithm.

9. The method of claim 8, wherein the second order phase correction algorithm is of the form:
φₑₛₜ=a·t²+b·t+c,
where a, b, and c are determined parameters and t is time.

10. The method of claim 1, wherein the super frame comprises a plurality of OFDM symbols.

11. The method of claim 10, wherein the super frame comprises 1200 OFDM symbols.

12. The method of claim 1, further comprising partitioning the super frame into four segments.

13. The method of claim 1, further comprising computing noise variance with respect to the transmitter based at least in part upon the corrected phase.

14. The method of claim 1, further comprising averaging a plurality of channel estimations based at least in part upon the corrected phase.

15. The method of claim 1, further comprising empirically determining a number of segments.

16. The method of claim 1, wherein estimating and correcting phase with respect to at least one of the plurality of segments occurs within a test receiver.

17. The method of claim 1, wherein estimating and correcting phase with respect to at least one of the plurality of segments occurs within a computing device.

18. The method of claim 1, wherein estimating and correcting phase with respect to at least one of the plurality of segments is undertaken to substantially cancel nonlinear noise.

19. A wireless communications apparatus, comprising:
a memory that retains instructions for segmenting a super frame with respect to time upon receipt of the super frame and further retains instructions for correcting phase alteration with respect to the super frame; and
a processor that executes the instructions retained within memory to correct phase alteration with respect to at least one segment of the super frame.

20. The wireless communications apparatus of claim 19, wherein the processor utilizes a first order phase correction algorithm in connection with correcting the phase alteration.

21. The wireless communications apparatus of claim 20, wherein the first order phase correction algorithm is a least square based phase correction algorithm.

22. The wireless communications apparatus of claim 19, wherein the processor utilizes a second order phase correction algorithm in connection with correcting the phase alteration.

23. The wireless communications apparatus of claim 22, wherein the second order phase correction algorithm is a least square based phase correction algorithm.

24. The wireless communications apparatus of claim 19 being a test receiver.

25. The wireless communications apparatus of claim 19, wherein the processor further executes instructions for determining modulation error ratio with respect to a transmitter.

26. The wireless communications apparatus of claim 25, wherein the transmitter is a FLO transmitter.

27. The wireless communications apparatus of claim 25, wherein the processor further executes instructions for determining quantization noise with respect to the super frame.

28. A wireless communications apparatus, comprising:
means for partitioning a super frame received from a transmitter into a plurality of segments;
means for performing phase correction with respect to at least one of the segments; and
means for determining a performance metric with respect to the transmitter based at least in part upon the phase correction.

29. The wireless communications apparatus of claim 28, wherein the performance metric is a modulation error ratio.

30. The wireless communications apparatus of claim 28, wherein the performance metric is an amount of quantization noise.

31. The wireless communications apparatus of claim 28, further comprising means for performing channel estimation based at least in part upon the phase correction.

32. A machine-readable medium having stored thereon machine-executable instructions for:
receiving a first portion of a super frame; and
estimating and correcting phase alteration with respect to the first portion in connection with testing performance of a transmitter.

33. The machine-readable medium of claim 32, further comprising machine-executable instructions for:
receiving a second portion of the super frame; and
estimating and correcting phase alteration with respect to the second portion in connection with testing performance of the transmitter.

34. The machine-readable medium of claim 32, wherein the transmitter is a FLO transmitter.

35. The machine-readable medium of claim 32, wherein the super frame comprises multiple OFDM symbols.

36. The machine-readable medium of claim 35, wherein the super frame comprises 1200 OFDM symbols.

37. The machine-readable medium of claim 32, further comprising machine-executable instructions for determining modulation error ratio based at least in part upon the corrected phase alteration.

38. A processor that executes the following instructions:
determining timing information in connection with segmenting a received signal, the received signal includes multiple symbols;
segmenting the received signal in accordance with the determining timing information;
correcting phase alteration with respect to at least one segment of the received signal, the at least one segment comprises two or more symbols; and
determining whether a transmitter is performing within predefined specifications based at least in part upon the corrected phase alteration.

39. The processor of claim 38, wherein the symbols are OFDM symbols.

40. The processor of claim 38, wherein the received signal is a super frame.
